(19) United States
(12) Patent Application Publication
(10) Pub. No.: US 2017/0064297 A1
(43) Pub. Date: Mar. 2, 2017

(54) ARRAY TEST DEVICE AND ARRAY TEST METHOD FOR DISPLAY PANEL

(71) Applicant: Samsung Display Co., LTD., Yongin-si (KR)

(72) Inventors: Joon-Geol KIM, Suwon-si (KR); Si-Joon KIM, Seoul (KR); Hee-Seon KIM, Suwon-si (KR)

(21) Appl. No.: 15/058,659

(22) Filed: Mar. 2, 2016

(30) Foreign Application Priority Data
Aug. 24, 2015 (KR) 10-2015-0118663

(51) Int. Cl. H04N 17/00

(52) U.S. Cl. CPC H04N 17/004

(57) ABSTRACT

An array test device for a display panel includes a stage on which the display panel including a plurality of pixel circuits is disposed, a contact unit including a plurality of probe pins, an adjustment unit which adjusts the contact unit such that the probe pins contact a plurality of pads of the display panel, and a testing unit which applies an array test signal to the pixel circuits of the display panel through the probe pins and the pads, receives a test result signal from the pixel circuits through the pads and the probe pins, generates waveform information representing a waveform of the test result signal, and determines whether the pixel circuits are defective based on the waveform information.

This application claims priority to Korean Patent Application No. 10-2015-0118663, filed on Aug. 24, 2015, and all the benefits accruing therefrom under 35 U.S.C. §119, the content of which in its entirety is herein incorporated by reference.

### BACKGROUND

1. Field

Exemplary embodiments relate generally to test devices. More particularly, exemplary embodiments relate to array test devices and array test methods for display panels.

2. Description of the Related Art

After pixel circuits of which each includes a transistor and a capacitor are formed on a display panel, such as an organic light emitting diode (“OLED”) display panel, an array test may be performed to determine whether the pixel circuits are defective. A display panel that is determined to be a defective product by the array test may be repaired by a repair process. Alternatively, in case that the defective display panel cannot be repaired, the defective display panel may be discarded, and subsequent panel processes (or cell processes) and module processes for the defective display panel may not be performed. Accordingly, since the subsequent processes are not performed, overall manufacturing time for display panels may be reduced.

### SUMMARY

In a conventional array test, a defective pixel circuit is detected based on a peak value of a signal that is output from the pixel circuit. Since only the peak value is considered in determining whether the pixel circuit is defective, the conventional array test may have low accuracy.

Exemplary embodiments provide an array test device improving accuracy of defect determination and detection by an array test.

Exemplary embodiments provide an array test method improving accuracy of defect determination and detection by an array test.

According to exemplary embodiments, there is provided an array test device for a display panel including a stage on which the display panel including a plurality of pixel circuits is disposed, a contact unit including a plurality of probe pins, an adjustment unit which adjusts the contact unit such that the probe pins contact a plurality of pads of the display panel, and a testing unit which applies an array test signal to the pixel circuits of the display panel through the probe pins and the pads, receives a test result signal from the pixel circuits through the pads and the probe pins, generates waveform information representing a waveform of the test result signal, and determines whether the pixel circuits are defective based on the waveform information.

In exemplary embodiments, when the waveform information of at least one of the pixel circuits is different from the waveform information of others of the pixel circuits, the testing unit may determine that the at least one of the pixel circuits is defective.

In exemplary embodiments, the testing unit may sequentially receive the test result signal from the pixel circuits, and, when the waveform information of the sequentially received test result signal is changed, the testing unit may determine that at least one of the pixel circuits outputting the test result signal of which the waveform information is changed is a defective pixel circuit.

In exemplary embodiments, the testing unit may sample the test result signal at a plurality of sampling points with respect to each of the pixel circuits, and may generate the waveform information based on values of the test result signal sampled at the sampling points.

In exemplary embodiments, the testing unit may extract at least one vector corresponding to the waveform of the test result signal based on the values of the test result signal sampled at the sampling points, and may generate the waveform information representing the vector.

In exemplary embodiments, the vector extracted by the testing unit may be a vector having, as a start point and an end point, two points at which a slope of the waveform of the test result signal is changed.

In exemplary embodiments, the testing unit may determine whether the pixel circuits are defective based on at least one of a number of the at least one vector, a magnitude of the at least one vector and a direction of the at least one vector included in the waveform information.

In exemplary embodiments, the testing unit may perform matching of the values of the test result signal sampled at the sampling points to a predetermined function, and may generate the waveform information representing coefficients of the predetermined function.

In exemplary embodiments, the testing unit may include an array test signal generating unit which generates the array test signal, and to apply the array test signal to the probe pins, a waveform information generating unit which receives the test result signal form the pixel circuits through the probe pines, and to generate the waveform information for the test result signal, and a defect determining unit which determines whether the pixel circuits are defective based on the waveform information.

In exemplary embodiments, the pads contacting the probe pins may be array test-dedicated pads included in the display panel.

In exemplary embodiments, the array test device may perform an array test for the display panel before a data driving unit is mounted on the display panel.

According to exemplary embodiments, there is provided an array test method for a display panel including a plurality of pixel circuits. In the method, an array test signal is applied to the pixel circuits of the display panel through a plurality of probe pins and a plurality of pads of the display panel that the probe pins contact, a test result signal is received from the pixel circuits through the pads and the probe pins, waveform information representing a waveform of the test result signal is generated, and whether the pixel circuits are defective is determined based on the waveform information.

In exemplary embodiments, when the waveform information of at least one of the pixel circuits is different from the waveform information of others of the pixel circuits, the at least one of the pixel circuits may be determined to be defective.

In exemplary embodiments, wherein the test result signal may be sequentially received from the pixel circuits, and, when the waveform information of the sequentially received test result signal is changed, at least one of the pixel circuits outputting the test result signal of which the waveform information is changed may be determined to be a defective pixel circuit.

In exemplary embodiments, to the waveform information, the test result signal may be sampled at a plurality of sampling points with respect to each of the pixel circuits, and the waveform information may be generated based on values of the test result signal sampled at the sampling points.

In exemplary embodiments, at least one vector corresponding to the waveform of the test result signal may be extracted based on the values of the test result signal sampled at the sampling points, and the waveform information may represent the vector.

In exemplary embodiments, the extracted vector may be a vector having, as a start point and an end point, two points at which a slope of the waveform of the test result signal is changed.

In exemplary embodiments, whether the pixel circuits are defective may be determined based on at least one of a number of the at least one vector, a magnitude of the at least one vector and a direction of the at least one vector included in the waveform information.

In exemplary embodiments, the values of the test result signal sampled at the sampling points may be matched to a predetermined function, and the waveform information may represent coefficients of the predetermined function.

In exemplary embodiments, the array test method may be performed before a data driving unit is mounted on the display panel.

As described above, the array test device and the array test method according to exemplary embodiments may determine whether a pixel circuit is defective based on waveform information of a test result signal that is output from the pixel circuit in response to an array test signal, thereby improving accuracy of defect determination and detection by an array test.

### BRIEF DESCRIPTION OF THE DRAWINGS

Illustrative, non-limiting exemplary embodiments will be more clearly understood from the following detailed description taken in conjunction with the accompanying drawings.

FIG. 1 is a flowchart illustrating exemplary embodiments of a method of manufacturing a display panel.

FIG. 2 is a block diagram illustrating exemplary embodiments of an array test device.

FIG. 3 is a block diagram illustrating an exemplary embodiment of a display panel.

FIG. 4 is a block diagram illustrating an exemplary embodiment of a testing unit.

FIG. 5 is a diagram illustrating an exemplary embodiment of waveform information generated by an array test device.

FIG. 6 is a flowchart illustrating an exemplary embodiment of an array test method.

FIG. 7 is a diagram illustrating an exemplary embodiment of waveform information generated by an array test method.

### DETAILED DESCRIPTION

The exemplary embodiments are described more fully hereinafter with reference to the accompanying drawings. Like or similar reference numerals refer to like or similar elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

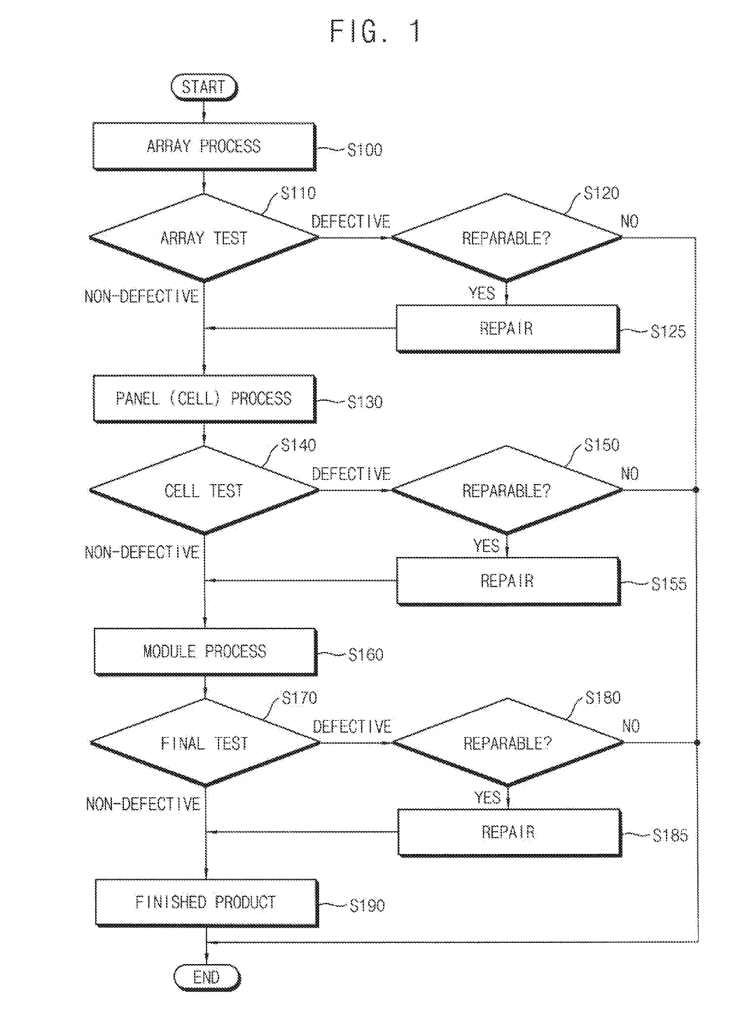

FIG. 1 is a flowchart illustrating a method of manufacturing a display panel according to exemplary embodiments.

Referring to FIG. 1, an array process may be performed to form a pixel circuit array on a substrate of a display panel (S100). The pixel circuit array may include a plurality of pixel circuits arranged in a matrix having a plurality of rows and a plurality of columns, and each pixel circuit may include at least one thin film transistor and at least one capacitor.

After the array process is performed, an array test may be performed to detect whether the pixel circuit array is defective (S110). By the array test, it is tested whether the transistor included in each pixel circuit operates normally, whether lines connected to each pixel circuit have a defect (e.g., a short circuit), or the like. The array test according to exemplary embodiments may be performed by applying an array test signal to the pixel circuit and by analyzing a test result signal that is output from the pixel circuit in response to the array test signal. In an exemplary embodiment, the array test may generate waveform information representing a waveform of the test result signal, and may determine whether the pixel circuit is defective based on the waveform information of the test result signal, for example. In a conventional array test, whether the pixel circuit is defective is determined based on a peak value of the test result signal. Thus, even when the test result signal of a defective pixel circuit has a waveform different from waveforms of the test result signals of other pixel circuits, the defective pixel circuit may be determined not to be defective by the conventional array test when a peak value of the test result signal of the defective pixel circuit is substantially the same as peak values of the test result signals of other pixel circuits. However, in the array test according to exemplary embodiments, whether the pixel circuit is defective is determined based on the waveform information of the test result signal, thereby improving accuracy of defect determination and detection for the pixel circuit.

When the pixel circuit is determined to be defective by the array test (S110: DEFECTIVE), it is determined whether the pixel circuit is reparable (S120). When the defective pixel circuit is reparable (S120: YES), the defective pixel circuit may be repaired by a repair process (S125). A yield of the display panel may be improved by the repair process. When the defective pixel circuit is irreparable (S120: NO), a subsequent process (e.g., a panel or cell process, a module process, etc.) may not be performed with respect to the display panel including the defective pixel circuit. Accordingly, since no subsequent process is performed, overall manufacturing time for the display panel may be reduced.

When all pixel circuits are determined to be non-defective (S110: NON-DEFECTIVE), or when the defective pixel circuit is repaired (S125), a panel (or cell) process may be performed to form an organic light emitting diode (“OLED”) including an anode electrode, an organic light emitting layer and a cathode electrode on the pixel circuit array (S130). Subsequently, a cell test including a panel lighting test, a leakage current test and/or an aging test may be performed (S140). When the display panel is determined to be defective by the cell test (S140: DEFECTIVE), it is determined whether the display panel is reparable (S150). When the defective display panel is reparable (S150: YES), the defective display panel may be repaired by a repair process (S155). When the defective display panel is irreparable (S150: NO), a subsequent process (e.g., a module process, etc.) may not be performed with respect to the defective display panel.

When the display panel is determined to be non-defective (S140: NON-DEFECTIVE), or when the defective display panel is repaired (S155), a module process for the display panel may be performed (S160), and then a final test may be performed (S170). The display panel determined to be non-defective by the final test may be determined as a finished product (S170: NON-DEFECTIVE and S190), and the display panel determined to be defective may be repaired or discarded according to whether the defective display panel is reparable (S170: DEFECTIVE, S180, S185 and S190).

As described above, in the a method of manufacturing the display panel according to exemplary embodiments, the array test may be performed after the array process, and the pixel circuit determined to be defective by the array test may be repaired, thereby improving the yield of the display panel. Further, in the array test, whether the pixel circuit is defective is determined based on the waveform information of the test result signal, thereby improving the accuracy of the array test.

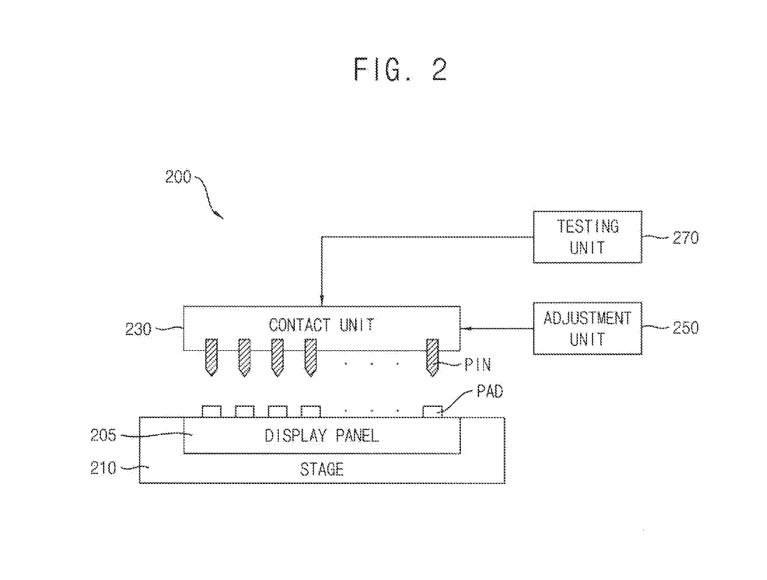

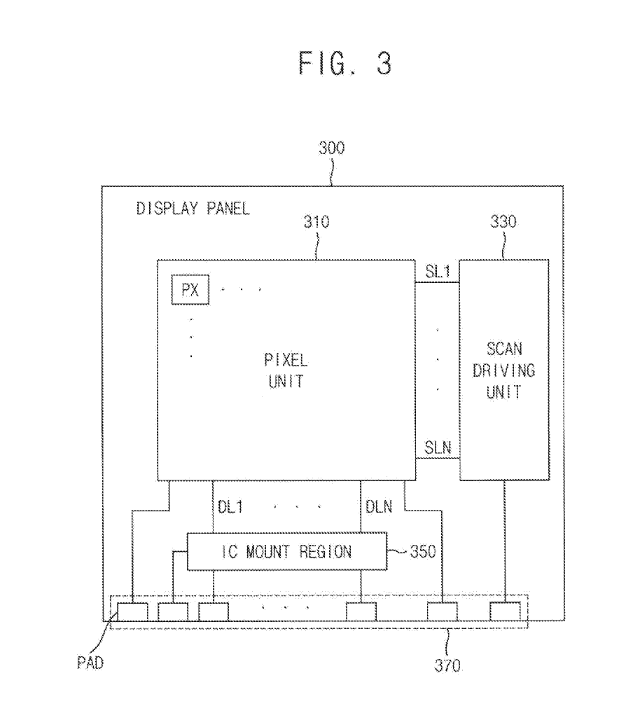

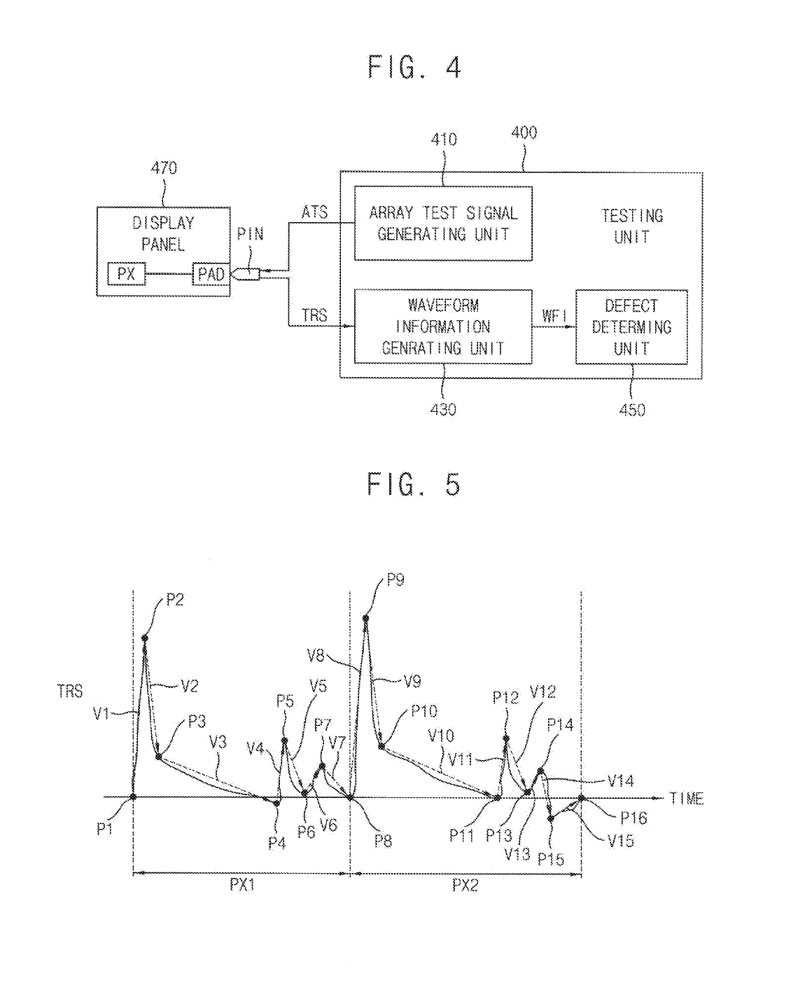

FIG. 2 is a block diagram illustrating an array test device according to exemplary embodiments, FIG. 3 is a block diagram illustrating an exemplary embodiment of a display panel, FIG. 4 is a block diagram illustrating an exemplary embodiment of a testing unit, and FIG. 5 is a diagram illustrating an exemplary embodiment of waveform information generated by an array test device.

Referring to FIG. 2, an array test device 200 may perform an array test for a display panel 205, and may include a stage 210, a contact unit 230, an adjustment unit 250 and a testing unit 270.

The display panel 205 may be disposed (e.g., loaded) on the stage 210. In exemplary embodiments, the display panel 205 may be an OLED display panel, a liquid crystal display (“LCD”) panel, or the like, for example.

In an exemplary embodiment, referring to FIG. 3, a display panel 300 may include a pixel unit 310, a scan driving unit 330, an integrated circuit (“IC”) mount region 350 and a pad unit 370, for example.

The pixel unit 310 may include a plurality of pixel circuits PX that are located at the intersection of scan lines SL1 to SLN and data lines DL1 to DLN, where N is a natural number. However, the invention is not limited thereto, and a number of the scan lines and a number of the data lines may be different from each other. The array test device 200 may perform the array test for the display panel 300 before an OLED connected to each pixel circuit PX is formed.

The scan driving unit 330 may be connected to the pixel unit 310 through the scan lines SL1 to SLN. In exemplary embodiments, the scan driving unit 330 may sequentially provide scan signals to the pixel circuits PX through the scan lines SL1 to SLN in response to signals provided through the pad unit 370. In an exemplary embodiment, the scan driving unit 330 may receive a scan driving voltage, a start pulse, a scan clock signal, an output enable signal, etc., for example. During the array test, the array test device 200 may provide these signals to the scan driving unit 330 through the pad unit 370, for example.

Data pads connected to the pixel unit 310 through the data lines DL1 to DLN may be arranged on the IC mount region 350. During the array test, the array test device 200 may apply an array test signal to pads PAD of the pad unit 370, and the array test signal applied to the pads PAD may be provided to the pixel circuits PX of the pixel unit 310 through the data pads and the data lines DL1 to DLN. Further, a test result signal output from the pixel circuits PX in response to the array test signal may be provided to the array test device 200 through the data pads and the pads PAD. After the array test is performed by the array test device 200, a data driving unit may be mounted on the IC mount region 350 such that the data driving unit is bonded to the data pads in a chip-on-glass (“COG”) method, for example. The data driving unit may provide data signals to the pixel circuits PX through the data lines DL1 to DLN.

The pad unit 370 may include the plurality of pads PAD for transferring power supply voltages and/or signals from an external device to an internal circuit of the display panel 300. In exemplary embodiments, the array test device 200 may apply the array test signal through the pads PAD of the pad unit 370, and may receive the test result signal through the pads PAD of the pad unit 370. In other exemplary embodiments, array test-dedicated pads connected to the data pads may be further formed on the display panel 300, and the array test device 200 may apply the array test signal and may receive the test result signal through the array test-dedicated pads. Thus, probe pins PIN of the array test device 200 may contact the array test-dedicated pads of the display panel 300. In an exemplary embodiment, the array test-dedicated pads may have a size and an interval greater than a size and an interval of the pads PAD of the pad unit 370, and thus may be readily contacted with the probe pins PIN of the array test device 200, for example. Here, the “pad” may mean a typical pad included in the pad unit 370, or may mean the array test-dedicated pad.

Referring back to FIG. 2, the contact unit 230 of the array test device 200 may include the plurality of probe pins PIN. The adjustment unit 250 of the array test device 200 may adjust a position of the contact unit 230 such that the probe pins PIN of the contact unit 230 contact the pads PAD of the display panel 205. Accordingly, the testing unit 270 of the array test device 200 may apply the array test signal to the pixel circuits PX of the display panel 205 through the probe pins PIN and the pads PAD, and may receive the test result signal from the pixel circuits PX of the display panel 205 through the pads PAD and the probe pins PIN. In exemplary embodiments, while the testing unit 270 applies the array test signal (e.g., a voltage or a current) to the pixel circuits PX through the probe pins PIN and the pads PAD, the testing unit 270 may measure an electrical signal (e.g., a current or a voltage) on the probe pins PIN as the test result signal. Further, the testing unit 270 may extract waveform information representing a waveform of the test result signal from the test result signal, and may determine whether the pixel circuits PX of the display panel 205 are defective based on the waveform information of the test result signal.

In an exemplary embodiment, as illustrated in FIG. 4, a testing unit 400 may include an array test signal generating unit 410, a waveform information generating unit 430 and a defect determining unit 450. The array test signal generating unit 410 may generate an array test signal ATS that is an electrical signal (e.g., a voltage or a current) having a predetermined level, and may apply the array test signal ATS to a probe pin PIN. The array test signal ATS applied to the probe pin PIN may be applied to a pixel circuit PX through a pad PAD of a display panel 470 that the probe pin PIN contacts. The pixel circuit PX may output a test result signal TRS that is an electrical signal (e.g., a voltage or a current) having a waveform in response to the array test signal ATS, and the test result signal TRS output from the pixel circuit PX may be provide to the probe pin PIN contacting the pad PAD. Here, the meaning of outputting the test result signal TRS from the pixel circuit PX may include a change of an electrical signal (e.g., a current or a voltage) by the pixel circuit PX when the array test signal ATS is applied to the pixel circuit PX.

The waveform information generating unit 430 may receive the test result signal TRS through the probe pin PIN. In exemplary embodiments, the waveform information generating unit 430 may receive a current flowing through the probe pin PIN as the test result signal TRS while a voltage having a predetermined level is applied as the array test signal ATS to the probe pin PIN. The waveform information generating unit 430 may extract waveform information WFI representing a waveform of the test result signal TRS from the test result signal TRS. In an exemplary embodiment, the waveform information generating unit 430 may sample the test result signal TRS at a plurality of sampling points with respect to each pixel circuit, and may generate the waveform information WFI based on values of the test result signal TRS sampled at the sampling points.

In exemplary embodiments, the waveform information generating unit 430 may extract at least one vector corresponding to the waveform of the test result signal TRS based on the values of the test result signal TRS sampled at the sampling points, and may generate the waveform information WFI representing the vector. In an exemplary embodiment, the vector extracted by the waveform information generating unit 430 may be a vector having, as a start point and an end point, two points at which a slope of the waveform of the test result signal TRS is changed by more than a predetermined amount, for example.

In an exemplary embodiment, as illustrated in FIG. 5, a waveform of a test result signal TRS for a first pixel circuit PX1 may have first through eighth points P1, P2, P3, P4, P5, P6, P7 and P8 at which a slope of the waveform is changed by more than the predetermined amount, and the waveform information generating unit 430 may generate the waveform information WFI for the first pixel PX1 representing first through seventh vectors V1, V2, V3, V4, V5, V6 and V7 each having, as the start point and the end point, adjacent two points of the first through eighth points P1, P2, P3, P4, P5, P6, P7 and P8, for example. Further, a waveform of a test result signal TRS for a second pixel circuit PX2 may have eighth through sixteenth points P8, P9, P10, P11, P12, P13, P14, P15 and P16 at which a slope of the waveform is changed by more than the predetermined amount, and the waveform information generating unit 430 may generate the waveform information WFI for the second pixel PX2 representing eighth through fifteenth vectors V8, V9, V10, V11, V12, V13, V14 and V15 each having, as the start point and the end point, adjacent two points of the eighth through sixteenth points P8, P9, P10, P11, P12, P13, P14, P15 and P16. That is, the waveform information generating unit 430 may generate the waveform information WFI representing the waveform of the test result signal TRS with the vector.

In other exemplary embodiments, the waveform information generating unit 430 may perform matching of the values of the test result signal TRS sampled at the sampling points to a predetermined function (e.g., a polynomial function), and may generate the waveform information WFI representing coefficients of the matched function. Further, in exemplary embodiments, the waveform information generating unit 430 may differentiate the matched function, and may generate the waveform information WFI representing values extracted by the differentiation.

However, the waveform information WFI generated by the test result signal TRS may not be limited to the above-described vector expression or the function matching, and may be any information representing the waveform of the test result signal TRS.

The defect determining unit 450 may determine whether the pixel circuit PX is defective based on the waveform information WFI provided by the waveform information generating unit 430. In exemplary embodiments, when the waveform information WFI of at least one pixel circuit PX is different from the waveform information WFI of other pixel circuits PX, the defect determining unit 450 may determine that the at least one pixel circuit PX is defective. In other exemplary embodiments, during the array test, the scan driving unit 330 may sequentially provide a scan signal to the pixel circuits PX through the scan lines SL1 to SLN, and the testing unit 270 may sequentially receive the test result signal TRS from the pixel circuits PX. In case that the waveform information WFI of the sequentially received test result signal TRS is changed, the defect determining unit 450 may determine that at least one pixel circuit PX outputting the test result signal TRS of which the waveform information WFI is changed is a defective pixel circuit. In an exemplary embodiment, when first waveform information is generated with respect to a portion of pixel circuits PX connected to one data line, and, subsequently, second waveform information is generated with respect to the remaining portion of the pixel circuits PX, the first one of the remaining portion of the pixel circuits PX that initially outputs the test result signal TRS corresponding to the second waveform information may be determined as a defective pixel circuit, for example.

In exemplary embodiments, the waveform information generating unit 430 may generate the waveform information WFI representing at least one vector corresponding to the waveform of the test result signal TRS, and the defect determining unit 450 may determine whether the pixel circuits PX are defective based on at least one of the number, a magnitude and a direction of the at least one vector included in the waveform information WFI. In an exemplary embodiment, when the waveform information WFI for one of the pixel circuits PX includes the first number of vectors, and the waveform information WFI for others of the pixel circuits PX includes the second number of vectors, the defect determining unit 450 may determine that the one of the pixel circuits PX is a defective pixel circuit, for example. In other exemplary embodiments, when the waveform information WFI for one of the pixel circuits PX includes a vector having a first magnitude or a first direction, and the waveform information WFI for others of the pixel circuits PX includes a vector having a second magnitude or a second direction, the defect determining unit 450 may determine that the one of the pixel circuits PX is a defective pixel circuit

A conventional array test device determines whether a pixel circuit is defective based on a peak value of a test result signal. Thus, even when the test result signal of a defective pixel circuit has a waveform different from waveforms of test result signals of other pixel circuits, the defective pixel circuit may be determined not to be defective by the conventional array test device when a peak value of the test result signal of the defective pixel circuit is substantially the same as peak values of the test result signals of other pixel circuits. However, the array test device 200 according to exemplary embodiments may determine whether the pixel circuit is defective based on the waveform information of the test result signal, thereby improving accuracy of defect determination and detection by the array test device 200.

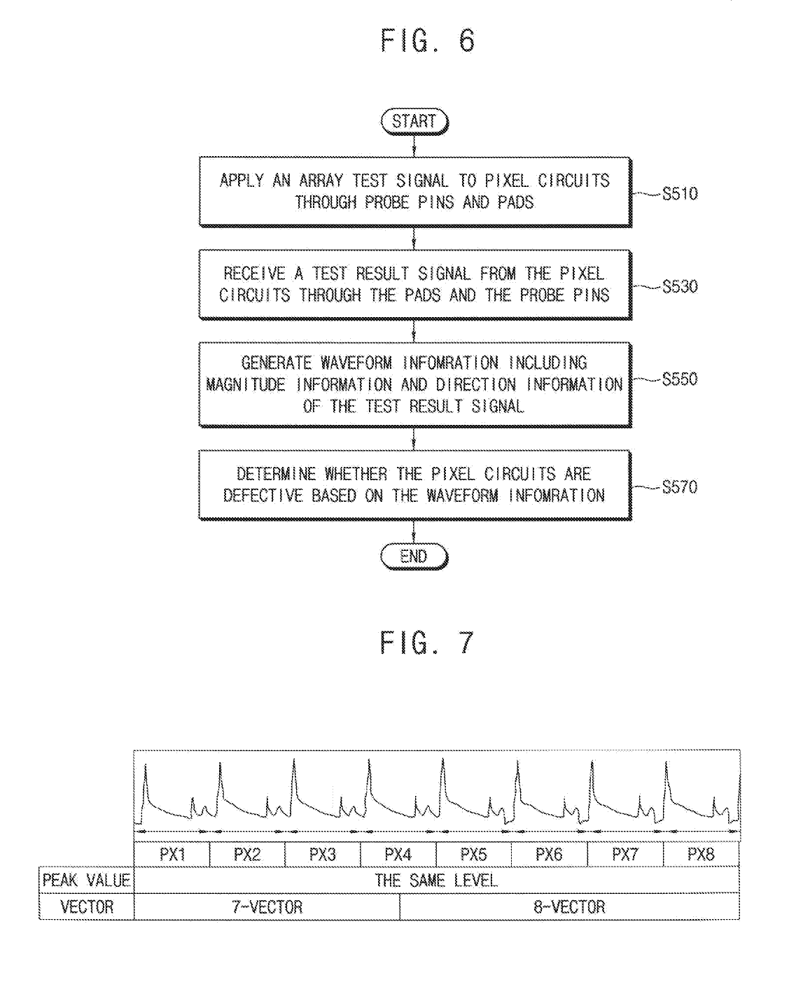

FIG. 6 is a flowchart illustrating an array test method according to exemplary embodiments, and FIG. 7 is a diagram illustrating an exemplary embodiment of waveform information generated by an array test method according to exemplary embodiments.

Referring to FIGS. 2 and 6, a testing unit 270 may apply an array test signal to pixel circuits of a display panel 205 through probe pins PIN of a contact unit 230 and pads PAD of the display panel 205 contacting the probe pins PIN (S510). The pixel circuits may output a test result signal in response to the array test signal.

The testing unit 270 may receive the test result signal from the pixel circuits through the pads PAD and the probe pins PIN (S530). The testing unit 270 may generate waveform information including magnitude information and direction information for the test result signal (S550). In an exemplary embodiment, the testing unit 270 may generate vector information as the waveform information by vectorizing the test result signal, for example. The testing unit 270 may determine whether the pixel circuits are defective based on the waveform information (S570).

In an exemplary embodiment illustrated in FIG. 7, an array test device 200 (refer to FIG. 2) may receive the test result signal from first through eighth pixel circuits PX1, PX2, PX3, PX4, PX5, PX6, PX7 and PX8 connected to one data line. In the exemplary embodiment of FIG. 7, the test result signal received from the first through fourth pixel circuits PX1, PX2, PX3 and PX4 may have a first waveform, and the test result signal received from the fifth through eighth pixel circuits PX5, PX6, PX7 and PX8 may have a second waveform. In this case, when the first waveform and the second waveform have substantially the same peak value, a conventional array test device cannot distinguish between the test result signal of the first through fourth pixel circuits PX1, PX2, PX3 and PX4 and the test result signal of the fifth through eighth pixel circuits PX5, PX6, PX7 and PX8. However, the array test device 200 according to exemplary embodiments may generate first waveform information with respect to the first through fourth pixel circuits PX1, PX2, PX3 and PX4, and may generate second waveform information different from the first waveform information with respect to the fifth through eighth pixel circuits PX5, PX6, PX7 and PX8. In the exemplary embodiment of FIG. 7, the array test device 200 may generate the first waveform information representing seven vectors with respect to the first through fourth pixel circuits PX1, PX2, PX3 and PX4, and may generate the second waveform information representing eight vectors with respect to the fifth through eighth pixel circuits PX5, PX6, PX7 and PX8, for example. Thus, the array test device 200 may distinguish between the test result signal of the first through fourth pixel circuits PX1, PX2, PX3 and PX4 and the test result signal of the fifth through eighth pixel circuits PX5, PX6, PX7 and PX8 based on the first waveform information and the second waveform information, and may determine that the fifth pixel circuit PX5 outputting the test result signal of which the waveform information is changed is a defective pixel circuit. Accordingly, in the array test method according to exemplary embodiments, the defect of the pixel circuit, which the conventional array test cannot detect, can be accurately detected.

As described above, in the array test method according to exemplary embodiments, whether the pixel circuit is defective is determined based on the waveform information of the test result signal, which results in the improvement of the accuracy of the defect determination and detection and the improvement of the accuracy of the array test.

The invention may be applied to array test devices and methods for performing array tests for display panels. In an exemplary embodiment, the invention may be applied to array test devices and methods for performing array tests for OLED display panels or LCD panels, for example.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the claims.

What is claimed is:

1. An array test device for a display panel, the array test device comprising:
a stage on which the display panel including a plurality of pixel circuits is disposed;
a contact unit including a plurality of probe pins;
an adjustment unit which adjusts the contact unit such that the plurality of probe pins contact a plurality of pads of the display panel; and
a testing unit which applies an array test signal to the plurality of pixel circuits of the display panel through the plurality of probe pins and the plurality of pads, receives a test result signal from the plurality of pixel circuits through the plurality of pads and the plurality of probe pins, generates waveform information representing a waveform of the test result signal, and determines whether the plurality of pixel circuits is defective based on the waveform information.

2. The array test device of claim 1, wherein, when the waveform information of at least one of the plurality of pixel circuits is different from the waveform information of others of the plurality of pixel circuits, the testing unit determines that the at least one of the plurality of pixel circuits is defective.

3. The array test device of claim 1, wherein the testing unit sequentially receives the test result signal from the plurality of pixel circuits, and
wherein, when the waveform information of the sequentially received test result signal is changed, the testing unit determines that at least one of the plurality of pixel circuits outputting the test result signal of which the waveform information is changed is a defective pixel circuit.

4. The array test device of claim 1, wherein the testing unit samples the test result signal at a plurality of sampling points with respect to each of the plurality of pixel circuits, and generates the waveform information based on values of the test result signal sampled at the sampling points.

5. The array test device of claim 4, wherein the testing unit extracts at least one vector corresponding to the waveform of the test result signal based on the values of the test result signal sampled at the sampling points, and generates the waveform information representing the vector.

6. The array test device of claim 5, wherein the vector extracted by the testing unit is a vector having, as a start point and an end point, two points at which a slope of the waveform of the test result signal is changed.

7. The array test device of claim 5, wherein the testing unit determines whether the plurality of pixel circuits is defective based on at least one of a number of the at least one vector, a magnitude of the at least one vector and a direction of the at least one vector included in the waveform information.

8. The array test device of claim 4, wherein the testing unit performs matching of the values of the test result signal sampled at the sampling points to a predetermined function, and generates the waveform information representing coefficients of the predetermined function.

9. The array test device of claim 1, wherein the testing unit includes:
an array test signal generating unit which generates the array test signal, and to apply the array test signal to the plurality of probe pins;
a waveform information generating unit which receives the test result signal form the plurality of pixel circuits through the probe pines, and to generate the waveform information for the test result signal; and
a defect determining unit which determines whether the plurality of pixel circuits is defective based on the waveform information.

10. The array test device of claim 1, wherein the plurality of pads contacting the plurality of probe pins is array test-dedicated pads included in the display panel.

11. The array test device of claim 1, wherein the array test device performs an array test for the display panel before a data driving unit is mounted on the display panel.

12. An array test method for a display panel including a plurality of pixel circuits, the method comprising:
applying an array test signal to the plurality of pixel circuits of the display panel through a plurality of probe pins and a plurality of pads of the display panel that the plurality of probe pins contact;
receiving a test result signal from the plurality of pixel circuits through the plurality of pads and the plurality of probe pins;
generating waveform information representing a waveform of the test result signal; and
determining whether the plurality of pixel circuits is defective based on the waveform information.

13. The method of claim 12, wherein, when the waveform information of at least one of the plurality of pixel circuits is different from the waveform information of others of the plurality of pixel circuits, the at least one of the plurality of pixel circuits is determined to be defective.

14. The method of claim 12, wherein the test result signal is sequentially received from the plurality of pixel circuits, and
wherein, when the waveform information of the sequentially received test result signal is changed, at least one of the plurality of pixel circuits outputting the test result signal of which the waveform information is changed is determined to be a defective pixel circuit.

15. The method of claim 12, wherein generating the waveform information includes:
sampling the test result signal at a plurality of sampling points with respect to each of the plurality of pixel circuits; and
generating the waveform information based on values of the test result signal sampled at the sampling points.

16. The method of claim 15, wherein at least one vector corresponding to the waveform of the test result signal is extracted based on the values of the test result signal sampled at the sampling points, and the waveform information represents the vector.

17. The method of claim 16, wherein the extracted vector is a vector having, as a start point and an end point, two points at which a slope of the waveform of the test result signal is changed.

18. The method of claim 16, wherein whether the plurality of pixel circuits is defective is determined based on at least one of a number of the at least one vector, a magnitude of the at least one vector and a direction of the at least one vector included in the waveform information.

19. The method of claim 15, wherein the values of the test result signal sampled at the sampling points are matched to a predetermined function, and the waveform information represents coefficients of the predetermined function.

20. The method of claim 12, wherein the array test method is performed before a data driving unit is mounted on the display panel.
